(19) United States
(12) Patent Application Publication
(10) Pub. No.: US 2022/0366306 A1
(43) Pub. Date: Nov. 17, 2022

(54) LEARNING REQUIREMENT GENERATION APPARATUS, LEARNING REQUIREMENT GENERATION METHOD, AND NON-TRANSITORY COMPUTER READABLE MEDIUM

(71) Applicant: NEC Corporation, Tokyo (JP)

(72) Inventors: Kazuki TANABE, Tokyo (JP); Takayuki Kuroda, Tokyo (JP)

(73) Assignee: NEC Corporation, Tokyo (JP)

(21) Appl. No.: 17/739,456

(22) Filed: May 9, 2022

(30) Foreign Application Priority Data
May 14, 2021 (JP) 2021-082306

(51) Int. Cl. G06N 20/00

(52) U.S. Cl. CPC G06N 20/00

(57) ABSTRACT

A learning requirement generation apparatus according to the present disclosure includes: a storage unit configured to store a system requirement group; a requirement acquisition unit configured to acquire the system requirement group from the storage unit and add the acquired system requirement group to an acquisition requirement group; and a learning requirement generation unit configured to generate a learning requirement by adding or replacing of a component on each of acquisition requirements that compose the acquisition requirement group.

### INCORPORATION BY REFERENCE

This application is based upon and claims the benefit of priority from Japanese patent application No. 2021-082306, filed on May 14, 2021, the disclosure of which is incorporated herein in its entirety by reference.

### TECHNICAL FIELD

The present disclosure relates to an automation technology for automating the evaluation of products that compose an Information Communication Technology (ICT) system. In particular, the present disclosure relates to a technology for generating learning requirements for a machine to learn design knowledge related to the design of an ICT system.

### BACKGROUND ART

The processes required to construct an ICT system include a design process for designing a concrete system configuration that meets the system requirements required for the ICT system.

International Patent Publication No. WO 2019/216082 discloses a technology for automatically generating a system configuration from system requirements for the purpose of automating a basic design process and a detailed design process. In this technology, a storage unit stores a concretization rule in which a method is specified for concretizing abstract configuration information (a system requirement) by confirming an unconfirmed portion of the abstract configuration information, which is information indicating a configuration of a system in which the unconfirmed portion is included. Further, the abstract configuration information included in configuration requirements of the system represented in the form of a graph is concretized using the concretization rule stored in the storage unit. By doing the above, information (a system configuration) indicating the configuration of the system in which the unconfirmed portion is not included is generated based on the configuration requirements of the system.

Non Patent Literature 1 (Takayuki KURODA, Takuya KUWAHARA, Takashi MARUYAMA, Yutaka YAKUWA, Kazuki TANABE, Tatsuya FUKUDA, Kozo SATODA, and Takao OSAKI, “Acquisition of Knowledge about ICT System Designing with Machine Learning”, The Transactions of the Institute of Electronics, Information and Communication Engineers Vol. J104-B, No. 3, pp. 140-151, March 2021) discloses an automatic design technology (a learning-type system automatic design technology) of an ICT system using machine learning inspired by International Patent Publication No. WO 2019/216082. In this technology, when a concrete system configuration is generated from the system requirement by the technology disclosed in International Patent Publication No. WO 2019/216082, a reward value is given to each of the generated system configuration and the concretization rule applied in the generation process, and Artificial Intelligence (AI) is made to learn the reward value for the system configuration and the concretization rule. By doing the above, AI can pseudo-acquire the knowledge (the design knowledge) related to a system design which an engineer possesses. Further, by learning the system configurations and the concretization rules for various types of system requirements and the reward values for these system configurations and concretization rules, it is possible to enhance the speed and the reliability of the design of a system configuration.

However, in the learning-type system automatic design technology disclosed in Non Patent Literature 1, like in the case of a common problem where a large amount of learning data is required when using AI, it is preferable that a large number of system requirements for learning (learning requirements) be prepared in order for AI to acquire necessary and sufficient design knowledge. Therefore, prior to learning, a problem may occur that a man-hour burden on an engineer who generates a large number of learning requirements described above becomes large.

The reason for the above is that it is necessary to prepare a large amount of information (actual case data) about the case for which a system design has actually been performed, and to manually interpret the content of the actual case data and then convert it into a requirement data format, which is an input format of the learning-type system automatic design technology, in order to generate the learning requirements.

Therefore, an object of the present disclosure is to solve the above-described problem and to provide a learning requirement generation apparatus, a learning requirement generation method, and a non-transitory computer readable medium that are capable of reducing the burden of generating learning requirements on an engineer.

### SUMMARY

A learning requirement generation apparatus according to an example aspect includes:

a storage unit configured to store a system requirement group;

a requirement acquisition unit configured to acquire the system requirement group from the storage unit and add the acquired system requirement group to an acquisition requirement group; and

a learning requirement generation unit configured to generate a learning requirement by adding or replacing of a component on each of acquisition requirements that compose the acquisition requirement group.

A learning requirement generation method according to an example aspect is a learning requirement generation method performed by a learning requirement generation apparatus, the learning requirement generation method including:

storing a system requirement group in a storage unit;

acquiring the system requirement group from the storage unit and adding the acquired system requirement group to an acquisition requirement group; and

generating a learning requirement by adding or replacing of a component on each of acquisition requirements that compose the acquisition requirement group.

A non-transitory computer readable medium according to an example aspect is a non-transitory computer readable medium storing a program for causing a computer to execute:

a procedure of storing a system requirement group in a storage unit;

a procedure of acquiring the system requirement group from the storage unit and adding the acquired system requirement group to an acquisition requirement group; and

a procedure of generating a learning requirement by adding or replacing of a component on each of acquisition requirements that compose the acquisition requirement group.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a configuration example of a learning requirement generation apparatus according to a first example embodiment;

FIG. 2 is an explanatory diagram showing an example of a description of component data;

FIG. 3 is an explanatory diagram showing an example of a description of a system requirement;

FIG. 4 is an explanatory diagram showing an example of a visual representation of the system requirement;

FIG. 5 is an explanatory diagram showing an example of a description of relationship data;

FIG. 6 is an explanatory diagram showing an example of a description of a system configuration;

FIG. 7 is an explanatory diagram showing an example of a visual representation of the system configuration;

FIG. 8 is an explanatory diagram showing an example of processing for adding a component performed by a learning requirement generation unit according to the first example embodiment;

FIG. 9 is an explanatory diagram showing an example of processing for replacing a component performed by the learning requirement generation unit according to the first example embodiment;

FIG. 10 is a flowchart showing an example of a flow of an overall operation performed by the learning requirement generation apparatus according to the first example embodiment;

FIG. 11 is a block diagram showing a configuration example of a learning requirement generation apparatus according to a second example embodiment;

FIG. 12 is an explanatory diagram showing an example of processing for acquiring a similarity requirement performed by a similarity requirement acquisition unit according to the second example embodiment;

FIG. 13 is a flowchart showing an example of a flow of an overall operation performed by the learning requirement generation apparatus according to the second example embodiment;

FIG. 14 is a flowchart showing an example of a flow of the overall operation performed by the learning requirement generation apparatus according to the second example embodiment;

FIG. 15 is a block diagram showing a configuration example of an automatic design system according to a third example embodiment;

FIG. 16 is an explanatory diagram showing an example of a concretization rule used in a learning-type system automatic design apparatus according to the third example embodiment;

FIG. 17 is an explanatory diagram showing an example of processing for designing a system configuration performed by the learning-type system automatic design apparatus according to the third example embodiment;

FIG. 18 is a flowchart showing an example of a flow of an overall operation performed by the automatic design system according to the third example embodiment; and

FIG. 19 is a block diagram showing a configuration example of a learning requirement generation apparatus according to a fourth example embodiment.

### EXAMPLE EMBODIMENT

Example embodiments of the present disclosure will be described hereinafter with reference to the drawings. Note that, for the clarification of the description, the following descriptions and the drawings are partially omitted and simplified as appropriate. Further, the same elements are denoted by the same reference numerals or symbols throughout the drawings, and redundant descriptions are omitted as necessary.

### First Example Embodiment

### <Configuration of First Example Embodiment>

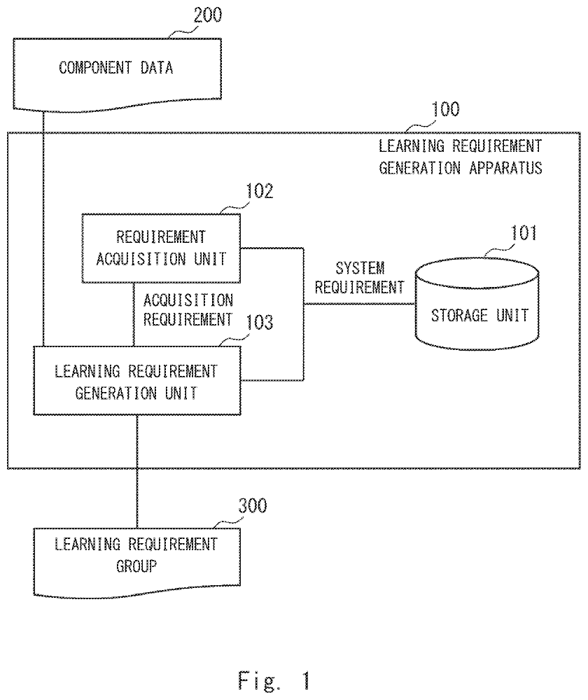

FIG. 1 shows a configuration example of a learning requirement generation apparatus 100 according to a first example embodiment. As shown in FIG. 1, the learning requirement generation apparatus 100 according to the first example embodiment includes a storage unit 101, a requirement acquisition unit 102, and a learning requirement generation unit 103. Upon receiving an input of component data 200, the learning requirement generation apparatus 100 outputs a learning requirement group 300.

The component data 200 describes definitions of types of components that compose an ICT system, such as an application, an Operation System (OS), and a server.

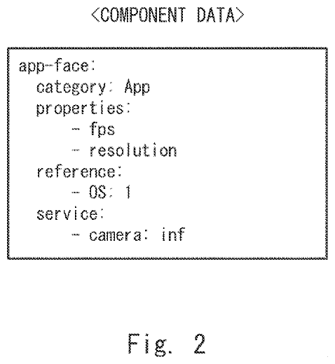

FIG. 2 shows an example of the component data 200 that describes the definition of an “app-face” type component representing a face authentication application.

As shown in FIG. 2, the definition of the component data 200 may include type information about a type of the component, attribute value information about an attribute value of component information such as configuration information of an application or OS, and information about another component that can be connected to a subject component by a relationship.

In the example shown in FIG. 2, “category” representing the type information of the component describes a value “App” indicating that the component is a type of an application.

Further, “properties” representing the attribute value information of the component describes, as the attribute values, “fps” representing a frame rate of a video image to be input to the face authentication application and “resolution” representing a resolution of the video image.

Further, as information about connection by the relationship between a subject component and another component, “reference” representing a connection request from the subject component to another component, which is required for the subject component to operate, and “service” representing a connection capability that can be provided to the other component requesting a connection to the subject component are defined. Both “reference” and “service” describe a pair of a port name of a port used for the connection and the number of components that can be connected to the port. In the example shown in FIG. 2, a pair “OS:1” is described as a value of “reference”. This indicates that the connection to one component has been requested, in accordance with a relationship using a port “OS” defined in relationship data described later, from the port “OS” connected to an OS required for the face authentication application to operate. Similarly, a pair “camera:inf” is described as a value of “service”. This indicates that a port “camera” connected to a camera for receiving the camera image can accept connections from a plurality of components in accordance with a relationship using the port “camera” defined in relationship data described later, and that no upper limit is set to the number of components that can be connected.

The system requirements, the component data 200, and the relationship data have been stored in the storage unit 101.

The system requirement is input to a learning-type system automatic design apparatus 310 described later, and is an abstract representation of components and constraints required for a system by a user.

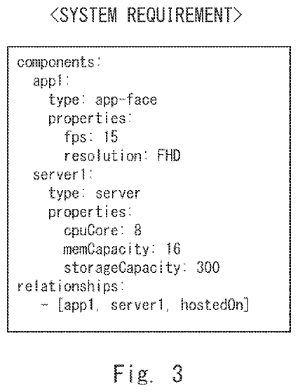

In FIG. 3, as an example of a system requirement, the definition of a system requirement using the face authentication application “app-face” is described.

As shown in FIG. 3, the definition of the system requirement may include information about components required for the system and information about the relationships between the components required for the system.

In the example shown in FIG. 3, in “components” representing the components required for the system, “app1” of the face authentication application, which is a component of the “app-face” type, and “server1” of a physical server, which is a component of a “server” type, are described. The definition of each component represented by “components” includes “type” representing a type name of the component and “properties” representing an attribute value of the component. In the attribute value of the component “app1”, “15” is described as a value of the above-described “fps”, and “FHD” is described as a value of the above-described “resolution”. Further, in the attribute values of the component “server1”, “8” is described as a value of “cpuCore” representing the number of cores of a Central Processing Unit (CPU) installed in the physical server, “16” indicating that 16 GBytes of memory is installed is described as a value of “memCapacity” representing a capacity of memory installed in the physical server, and “300” indicating that a capacity of a storage is 300 GBytes is described as a value of “storageCapacity” representing a capacity of a storage installed in the physical server.

Meanwhile, the definition of the relationship between the components represented by “relationships” includes a list of a set of three values: a start point and an end point of the relationship using the component names defined by the “components”, and a type name of the relationship. In the example shown in FIG. 3, the relationship [app1, server, hostedOn] indicates that the face authentication application “app1” is dependent on the physical server “server1” by an abstract relationship type “hostedOn” indicating that the application runs on the server.

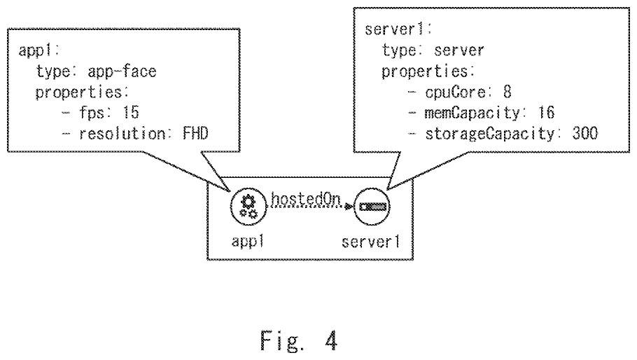

FIG. 4 is a visual representation of the details of the system requirement shown in FIG. 3 using a graphical structure. In the visual representation shown in FIG. 4, the components of the system are represented as nodes (vertices) and the relationships between the components are represented as edges (branches). In the following description of the specification, for the sake of convenience, the details of the system requirement will be described using a visual representation similar to that of FIG. 4. Note that a specific definition format of the system requirement is not limited to the examples shown in FIGS. 3 and 4.

The relationship data defines a type of relationship between the components of the system, which is used in the learning requirement generation apparatus 100 and the learning-type system automatic design apparatus 310 described later. The relationship data includes definitions of both abstract and concrete relationships. Further, the definition of each relationship includes information about types of the components of the system that can be connected by the relationship, in addition to information that distinguishes between the abstractness and the concreteness of the relationship.

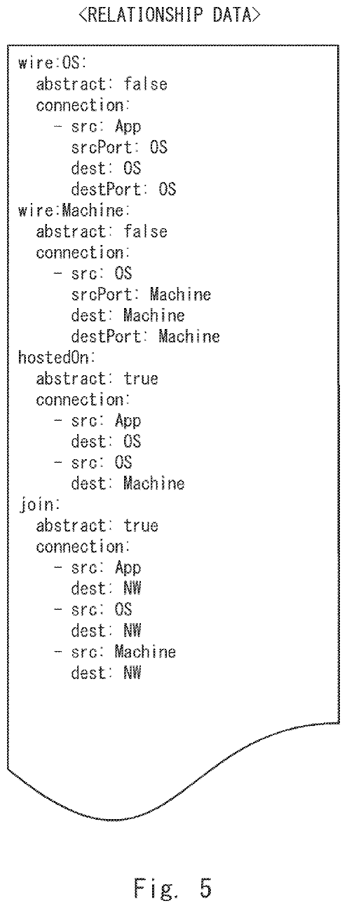

In FIG. 5, an example of the relationship data is described. In the example shown in FIG. 5, concrete relationship types “wire:OS” and “wire:Machine” and abstract relationship types “hostedOn” and “join” are defined.

The definition of each relationship includes “abstract” which is information that distinguishes between the abstractness and the concreteness of the relationship, and “connection” which is information about the components that can be connected by the relationship.

In “abstract”, a value of “true” indicates an abstract relationship, and a value of “false” indicates a concrete relationship.

In “connection”, at least one or more pairs of “src” representing a type of the component serving as the start point of the connection and “dest” representing a type of the component serving as the end point of the connection are defined in order to connect the components to each other by the relationship. The type of the component is represented by “category” in the component data 200 shown in FIG. 2. Further, “connection” of the concrete relationship further defines “srcPort” representing a port name of a port used for connection by the component serving as the start point of the connection and “destPort” representing a port name of a port used for connection by the component serving as the end point of the connection.

In the example shown in FIG. 5, the concrete relationship type “wire:OS” indicates that, using the port “OS” of the component “reference” of which the type is “App” as the start point and the port “OS” of the component “service” of which the type is “OS” as the end point, these two components can be connected to each other.

Meanwhile, since the abstract relationship is replaced with the concrete relationship by the learning-type system automatic design apparatus described later, the components are connected to each other without a port being specified. Note that a specific definition format of the relationship data is not limited to the example shown in FIG. 5.

A system configuration is a concrete representation of all the components of the system and the relationships between the components.

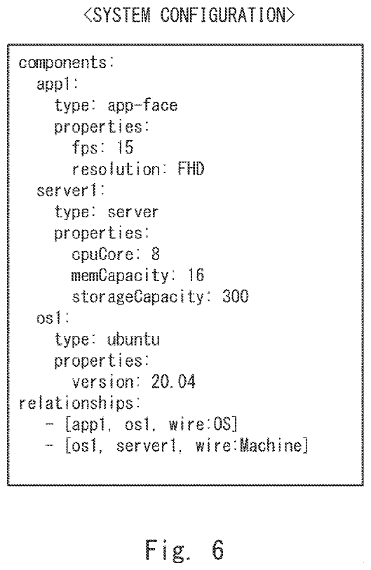

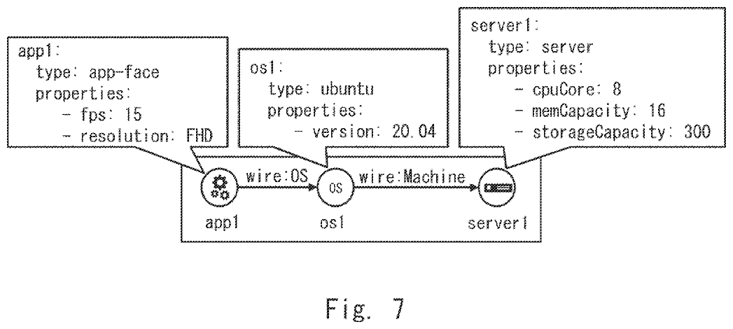

FIGS. 6 and 7 respectively show an example of the definition of the system configuration that meets the system requirement using the face authentication application “app-face” shown in FIGS. 3 and 4 and the visual representation thereof. As shown in FIG. 6, the definition of the system configuration may be described in a manner similar to that by which the system requirement is described.

In the examples shown in FIGS. 6 and 7, a component “os1” of an “ubuntu” type representing the Ubuntu Linux (registered trademark) OS has been newly added to implement the system requirements shown in FIGS. 3 and 4. In the attribute value of the component “os1”, a value “20.04” is described in “version” representing the version of the Ubuntu Linux (registered trademark) OS. Further, in order to implement an abstract relationship [app1, server1, hostedOn], the abstract relationship [app1, server1, hostedOn] is replaced with a concrete relationship [os1, server, wire:Machine] indicating that the OS “os1” is installed in the physical server “server1” and a concrete relationship [app1, os1, wire:OS] indicating that the application “app1” runs on the OS “os1”. Note that a specific definition format of the system configuration is not limited to the examples shown in FIGS. 6 and 7.

The requirement acquisition unit 102 acquires all the system requirements stored in the storage unit 101, and adds the acquired system requirements to an acquisition requirement group.

The learning requirement generation unit 103 inputs the component data 200. Further, the learning requirement generation unit 103 performs addition or replacement of a component on each of the acquisition requirements that compose the acquisition requirement group acquired by the requirement acquisition unit 102, thereby generating a system requirement (a learning requirement). Then the learning requirement generation unit 103 stores the generated learning requirement in the storage unit 101, and then adds it to the learning requirement group 300 and outputs the learning requirement group 300.

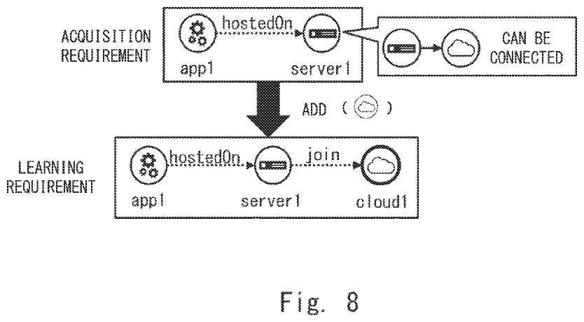

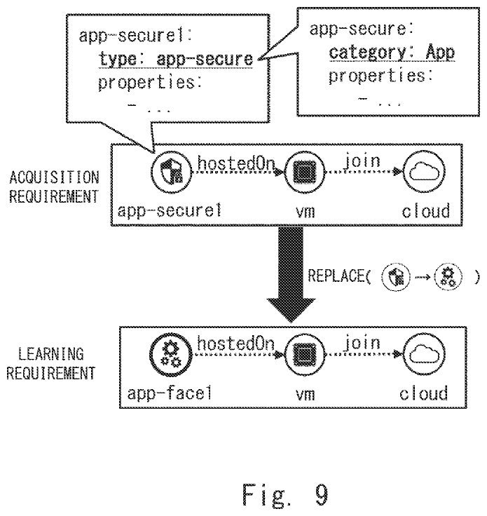

Each of FIGS. 8 and 9 shows an example of processing for generating a learning requirement for the acquisition requirement performed by the learning requirement generation unit 103.

FIG. 8 shows an example in which a component isomorphic to a component (an input component) represented by the input component data 200 is present in the acquisition requirement, and the input component in the acquisition requirement can be connected to a new component by a concrete or an abstract relationship. In this case, the learning requirement generation unit 103 adds a new component to the acquisition requirement and connects the added new component to the input component by the relationship, thereby generating a learning requirement.

In the example shown in FIG. 8, it is assumed that the acquisition requirement is an acquisition requirement in which the component “app1” and the component “server1” are connected by the abstract relationship “hostedOn”. It is also assumed that the component “server1” is an input component. It is also assumed that a connection from “server1” to a component “cloud1” representing a cloud network can be added by “join”, which is an abstract relationship representing a connection of the server to the network defined in the relationship data shown in FIG. 5. In this case, the learning requirement generation unit 103 adds a new component “cloud1” to the acquisition requirement, and generates, as a learning requirement, the acquisition requirement in which the added component “cloud1” is connected to the component “server1” by the relationship “join”.

Further, FIG. 9 shows an example in which no input component is present in the acquisition requirement and one of the components in the acquisition requirement can be replaced with the input component. In this case, the learning requirement generation unit 103 replaces the component in the acquisition requirement with the input component, thereby generating a learning requirement. At this time, as a method for determining the possibility of the replacement, type information (a type) of the component included in the definition of the component in the acquisition requirement and category information (a category) of the component included in the definition of the type may be used.

In the example shown in FIG. 9, it is assumed that the acquisition requirement is an acquisition requirement in which a component “app-secure1” representing a security application and a component “vm” representing a virtual machine are connected by the abstract relationship “hostedOn”, and the component “vm” and the component “cloud” representing a cloud network are connected by the abstract relationship “join”. It is also assumed that the component “app-secure1” in the acquisition requirement is a component of an “app-secure” type and that the component of the “app-secure” type is a component of which the category is “App”. It is also assumed that the input component is a component “app-face1” of the “app-face” type. In this case, the learning requirement generation unit 103 generates, as a learning requirement, the acquisition requirement in which the component “app-secure1” of the “app-secure” type of which the category is “App” is replaced with the input component “app-face1” of the “app-face” type.

### <Operation in First Example Embodiment>

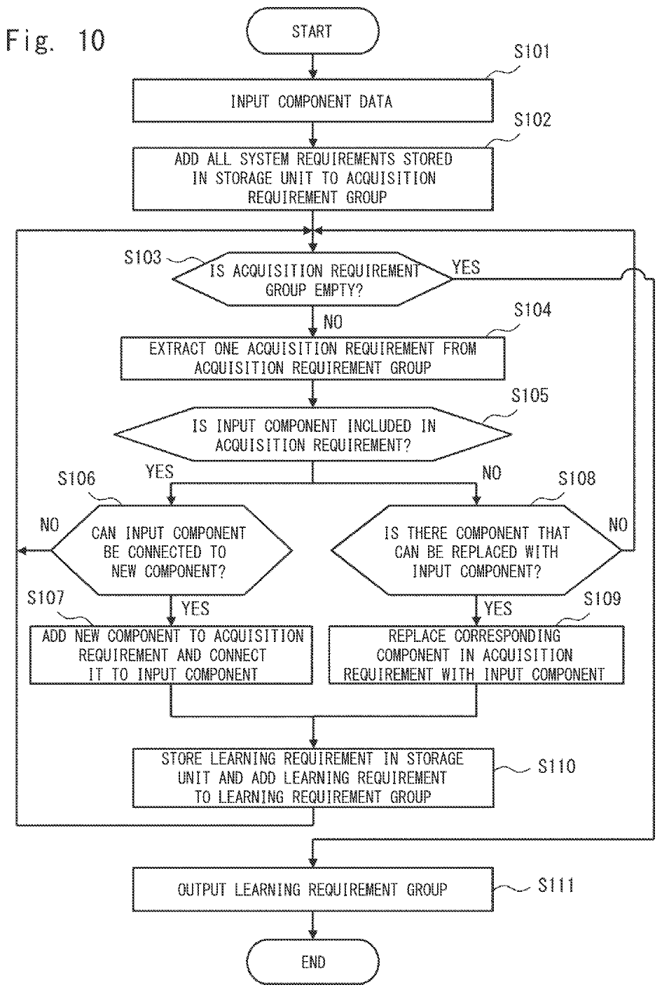

Next, an example of a flow of an overall operation performed by the learning requirement generation apparatus 100 according to the first example embodiment will be described with reference to a flowchart of FIG. 10.

As shown in FIG. 10, first, the learning requirement generation unit 103 inputs the component data 200 (Step S101).

Next, the requirement acquisition unit 102 acquires all the system requirements stored in the storage unit 101, and adds the acquired system requirements to the acquisition requirement group (Step S102).

Next, the learning requirement generation unit 103 determines whether or not the acquisition requirement group is empty (Step S103), and if the learning requirement generation unit 103 determines that the acquisition requirement group is not empty (NO in Step S103), it extracts one acquisition requirement from the acquisition requirement group (Step S104).

Next, the learning requirement generation unit 103 determines whether or not the component (the input component) represented by the component data 200 input in Step S101 is included in the acquisition requirement extracted in Step S104 (Step S105). If the learning requirement generation unit 103 determines that the input component is included in the acquisition requirement (YES in Step S105), the process proceeds to Step S106, while if it determines that the input component is not included in the acquisition requirement (NO in Step S105), the process proceeds to Step S108.

In Step S106, the learning requirement generation unit 103 determines whether or not the input component in the acquisition requirement can be connected to a new component by a concrete or an abstract relationship. If the learning requirement generation unit 103 determines that the input component can be connected to a new component (YES in Step S106), it adds a new component to the acquisition requirement, and connects the added component to the input component in the acquisition requirement by the relationship (Step S107). In this way, a learning requirement is generated. On the other hand, if the learning requirement generation unit 103 determines that the input component cannot be connected to a new component (NO in Step S106), it discards the acquisition requirement, and the process returns to Step S103.

In Step S108, the learning requirement generation unit 103 determines whether or not there is a component that can be replaced with the input component in the acquisition requirement. If the learning requirement generation unit 103 determines that the replacement of the corresponding component with the input component can be performed (YES in Step S108), it replaces the corresponding component in the acquisition requirement with the input component (Step S109). In this way, a learning requirement is generated. On the other hand, if the learning requirement generation unit 103 determines that the replacement of the corresponding component with the input component cannot be performed (NO in Step S108), it discards the acquisition requirement, and the process returns to Step S103.

After the execution of Step S107 or S109, the learning requirement generation unit 103 stores the learning requirement generated in Step S107 or S109 in the storage unit 101 and adds it to the learning requirement group 300 (Step S110). After that, the process returns to Step S103.

In Step S103, if the learning requirement generation unit 103 determines that the acquisition requirement group is empty (YES in Step S103), it outputs the learning requirement group 300 (Step S111), and ends the process.

### <Effect of First Example Embodiment>

As described above, the learning requirement generation apparatus 100 according to the first example embodiment performs processing for adding or replacing components on the system requirements stored in the storage unit 101 using the input component data 200, thereby generating learning requirements. Therefore, AI of the learning-type system automatic design technology can automatically generate the learning requirement group 300 required for acquisition of the design knowledge which an engineer possesses. Further, by inputting various types of component data 200 to the learning requirement generation apparatus 100 and repeatedly performing the processing for generating a learning requirement, it is possible to automatically generate a larger number of learning requirement groups 300.

By doing the above, it is possible to greatly reduce the burden on the engineer who has manually interpreted actual case data and prepared requirement data. It is also possible to enhance the accuracy and the speed of the learning-type system automatic design technology and to further reduce the labor needed for the design and construction processes of the ICT system.

### Second Example Embodiment

### <Configuration of Second Example Embodiment>

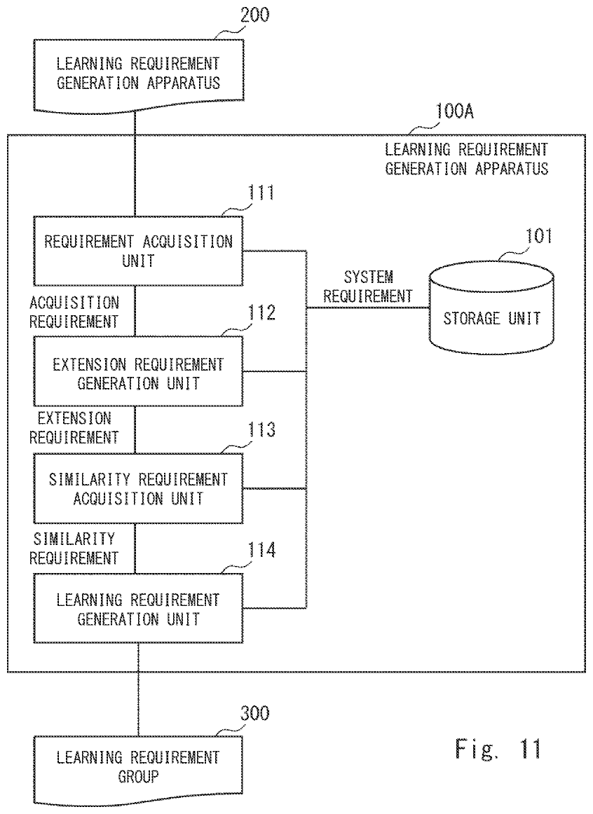

FIG. 11 shows a configuration example of a learning requirement generation apparatus 100A according to a second example embodiment. As shown in FIG. 11, the learning requirement generation apparatus 100A according to the second example embodiment includes the storage unit 101, a requirement acquisition unit 111, an extension requirement generation unit 112, a similarity requirement acquisition unit 113, and a learning requirement generation unit 114. Note that, in the second example embodiment, since the storage unit 101 is similar to that in the above-described first example embodiment, detailed descriptions thereof will be omitted.

The requirement acquisition unit 111 inputs the component data 200. Further, the requirement acquisition unit 111 refers to the system requirement group stored in the storage unit 101, acquires all the system requirements including the components (the input components) represented by the input component data 200, and adds the acquired system requirements to the acquisition requirement group.

The extension requirement generation unit 112 performs an operation similar to that performed in the example shown in FIG. 8 in the above-described first example embodiment on each of the acquisition requirements that compose the acquisition requirement group acquired by the requirement acquisition unit 111. That is, the extension requirement generation unit 112 determines whether or not the input component in the acquisition requirement can be connected to a new component by a concrete or an abstract relationship. When the extension requirement generation unit 112 determines that the input component can be connected to a new component, it adds a new component to the acquisition requirement and connects the added new component to the input component by the relationship, thereby generating a system requirement (an extension requirement). Further, the extension requirement generation unit 112 stores the generated extension requirement in the storage unit 101 and adds it to an extension requirement group.

For each of the extension requirements that compose the extension requirement group generated by the extension requirement generation unit 112, the similarity requirement acquisition unit 113 acquires a system requirement (a similarity requirement) that is similar to the corresponding extension requirement and that does not include the input component from the storage unit 101, and adds the acquired similarity requirements to a similarity requirement group.

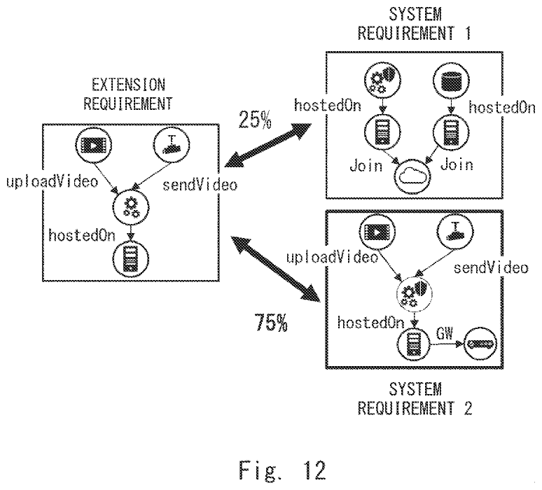

FIG. 12 shows an example of processing for acquiring a similarity requirement performed by the similarity requirement acquisition unit 113.

In the example shown in FIG. 12, the system requirement (the similarity requirement) having the highest similarity to the extension requirement generated by the extension requirement generation unit 112 is added to the similarity requirement group from among the system requirements that have been stored in the storage unit 101 and that does not include the input components. In the visual representation of each system requirement shown in FIG. 12, it is assumed that the nodes represented by the same symbol are components of the same type, and the edges with the same character string attached thereto are relationships of the same type. A Dice coefficient, which is one of the indices representing the similarity of sets, is used to determine the similarity between the system requirements. For two sets A and B, a Dice coefficient DSC (A, B) is expressed by the following Expression 1.

$$DSC ( A , B ) = \frac{2 \vert A ⋂ B \vert}{\vert A \vert + \vert B \vert} \qquad [ Expression 1 ]$$

When two system requirements, i.e., a system requirement 1 and a system requirement 2, have been stored in the storage unit 101 as system requirements that do not include input components, the similarity requirement acquisition unit 113 regards the system requirements as a set composed of nodes and edges and uses the aforementioned Expression 1. As a result, the similarity between the extension requirement and the system requirement 1 is 0.25 (25%), and the similarity between the extension requirement and the system requirement 2 is 0.75 (75%). Therefore, the similarity requirement acquisition unit 113 selects the system requirement 2 as a similarity requirement and acquires it. Note that a specific method for acquiring a similarity requirement is not limited to the example shown in FIG. 12.

The learning requirement generation unit 114 performs an operation similar to that performed in the example shown in FIG. 9 in the above-described first example embodiment on each of the similarity requirements that compose the similarity requirement group acquired by the similarity requirement acquisition unit 113. That is, the learning requirement generation unit 114 determines whether or not one of the components in the similarity requirement can be replaced with the input component. When the learning requirement generation unit 114 determines that the replacement of the corresponding component with the input component can be performed, it replaces the corresponding component in the similarity requirement with the input component, thereby generating a learning requirement. Then the learning requirement generation unit 103 stores the generated learning requirement in the storage unit 101 and adds it to the learning requirement group 300, and outputs the learning requirement group 300.

### <Operation in Second Example Embodiment>

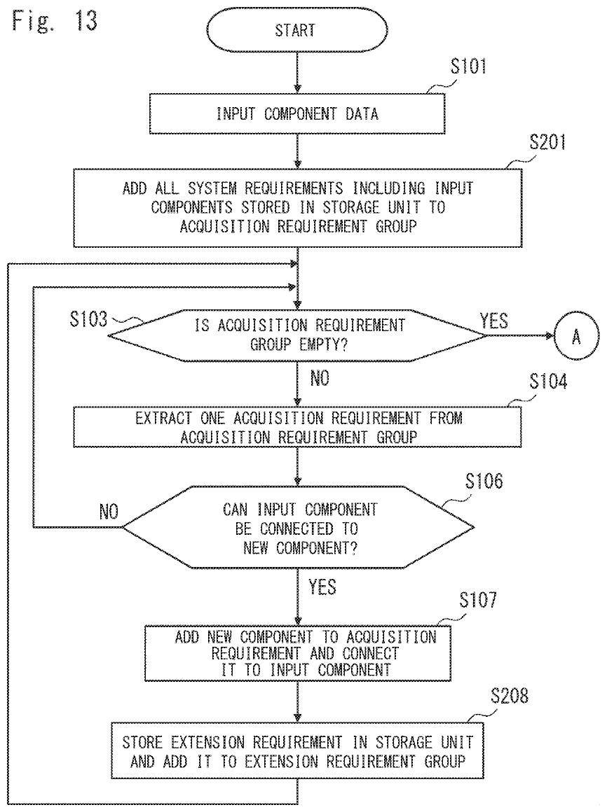

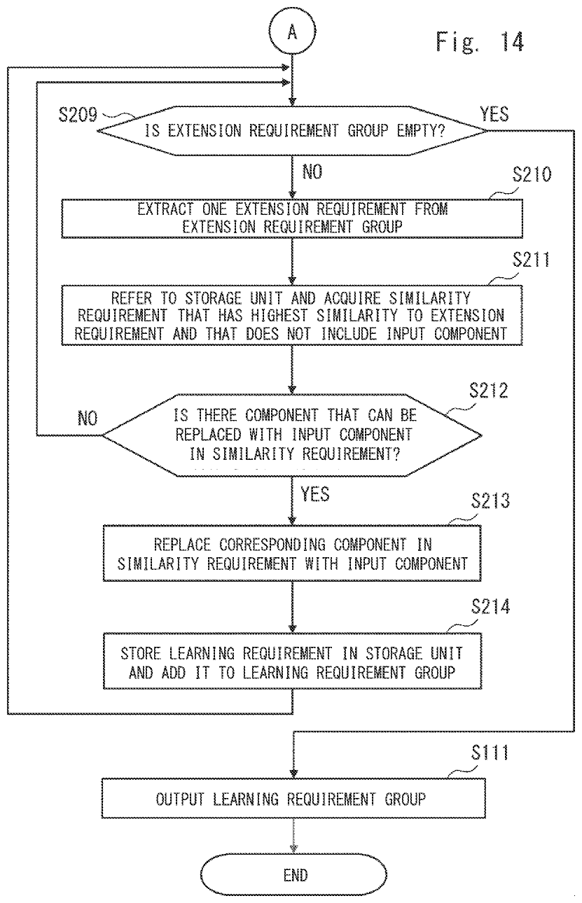

Next, an example of a flow of an overall operation performed by the learning requirement generation apparatus 100A according to the second example embodiment will be described with reference to flowcharts of FIGS. 13 and 14. In FIGS. 13 and 14, operations similar to those in FIG. 10 in the above-described first example embodiment are denoted by the same reference symbols, and detailed descriptions thereof will be omitted.

As shown in FIGS. 13 and 14, first, the requirement acquisition unit 111 inputs the component data 200 (Step S101).

Next, the requirement acquisition unit 111 acquires all the system requirements including the components (the input components) represented by the component data 200 input in Step S101 among the system requirements stored in the storage unit 101, and adds the acquired system requirements to the acquisition requirement group (Step S201).

Next, the extension requirement generation unit 112 determines whether or not the acquisition requirement group is empty (Step S103), and if the extension requirement generation unit 112 determines that the acquisition requirement group is not empty (NO in Step S103), it extracts one acquisition requirement from the acquisition requirement group (Step S104).

Next, the extension requirement generation unit 112 determines whether or not the input component in the acquisition requirement extracted in Step S104 can be connected to a new component by a concrete or an abstract relationship (Step S106). If the extension requirement generation unit 112 determines that the input component can be connected to a new component (YES in Step S106), it adds a new component to the acquisition requirement, and connects the added new component to the input component in the acquisition requirement by the relationship (Step S107). The extension requirement generation unit 112 stores the system requirement (the extension requirement) obtained in Step S107 in the storage unit 101 and adds it to the extension requirement group (Step S208). After that, the process returns to Step S103. On the other hand, if the extension requirement generation unit 112 determines that the input component cannot be connected to a new component (NO in Step S106), it discards the acquisition requirement, and the process returns to Step S103.

In Step S103, if it is determined that the acquisition requirement group is empty (YES in Step S103), the process proceeds to Step S209.

In Step S209, the similarity requirement acquisition unit 113 determines whether or not the extension requirement group is empty (Step S209), and if the similarity requirement acquisition unit 113 determines that the extension requirement group is not empty (NO in Step S209), it extracts one extension requirement from the extension requirement group (Step S210).

Next, among the system requirements stored in the storage unit 101, the similarity requirement acquisition unit 113 acquires the system requirement (the similarity requirement) that has the highest similarity to the extracted extension requirement and that does not include the input component (Step S211).

Next, the learning requirement generation unit 114 determines whether or not there is a component that can be replaced with the input component in the similarity requirement acquired in Step S211 (Step S212). If the learning requirement generation unit 114 determines that the replacement of the corresponding component with the input component can be performed (YES in Step S212), it replaces the corresponding component in the similarity requirement with the input component, thereby generating a system requirement (a learning requirement) (Step S213). The learning requirement generation unit 114 stores the learning requirement generated in Step S213 in the storage unit 101 and adds it to the learning requirement group 300 (Step S214). After that, the process returns to Step S209. On the other hand, if the learning requirement generation unit 114 determines that the replacement of the corresponding component with the input component cannot be performed (NO in Step S212), it discards the similarity requirement, and the process returns to Step S209.

In Step S209, if it is determined that the extension requirement group is empty (YES in Step S209), the learning requirement generation unit 103 outputs the learning requirement group 300 (Step S111), and ends the process.

### <Effect of Second Example Embodiment>

As described above, the learning requirement generation apparatus 100A according to the second example embodiment performs processing for replacing input components on the system requirements that do not include the components (the input components) represented by the component data 200, which have been stored in the storage unit 101, thereby generating the learning requirement group 300. Therefore, regarding the input components, it is possible to automatically generate a wider variety of the learning requirement groups 300 at a high speed. Further, both the extension requirement group generated by the extension requirement generation unit 112 and the learning requirement group generated by the learning requirement generation unit 114 are stored in the storage unit 101. Therefore, it is possible to store a wider variety of system requirements in the storage unit 101 at a higher speed.

The effects of the second example embodiment other than the above ones are similar to those of the above-described first example embodiment.

### Third Example Embodiment

### <Configuration of Third Example Embodiment>

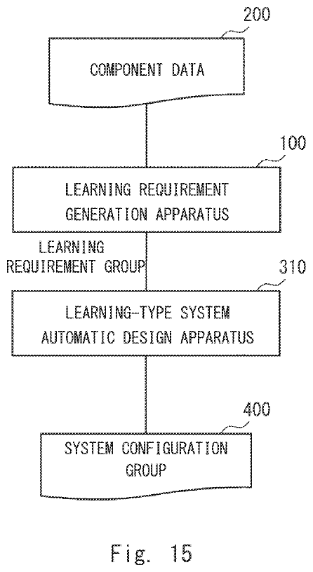

FIG. 15 shows a configuration example of an automatic design system according to a third example embodiment. As shown in FIG. 15, the automatic design system according to the third example embodiment includes the learning requirement generation apparatus 100 according to the above-described first example embodiment and the learning-type system automatic design apparatus 310. Upon receiving an input of the learning requirement group 300 generated by the learning requirement generation apparatus 100, the learning-type system automatic design apparatus 310 outputs a system configuration group 400.

As shown in Non Patent Literature 1, the learning-type system automatic design apparatus 310 sequentially applies a concretization rule in which a method is specified for partially concretizing an abstract element to the system requirement including an abstract component and relationship, thereby generating a large number of system configuration candidates in which all the elements are concretized. Further, the learning-type system automatic design apparatus 310 derives an evaluation value for each generated system configuration candidate by using a Graph Neural Network (GNN), which is a type of machine learning model using a graph structure, and gives a reward value to each concretization rule so that the reward value for the concretization rule applied in the process of generating the system configuration candidate having a large evaluation value becomes large. By doing the above, it is possible to make AI pseudo-learn the design knowledge which an engineer possesses.

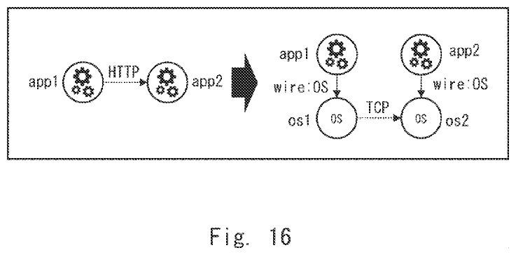

FIG. 16 shows an example of a concretization rule used in the learning-type system automatic design apparatus 310.

The concretization rule shown in FIG. 16 shows a method for concretizing an abstract Hyper Text Transfer Protocol (HTTP)-type edge representing HTTP communication between applications. In this concretization rule, the learning-type system automatic design apparatus 310 respectively connects the OS ports of the application-type nodes “app1” and “app2”, which are both end points of the HTTP-type edge, to the OS ports of the OS-type nodes “os1” and “os2” through the wire:OS-type edge, and hosts the application-type nodes on the respective OS-type nodes. Further, the learning-type system automatic design apparatus 310 connects the two OS-type nodes “os1” and “os2” to each other through a Transmission Control Protocol (TCP)-type edge representing an abstract TCP connection. Note that a method for defining a concretization rule is not limited to the example shown in FIG. 15.

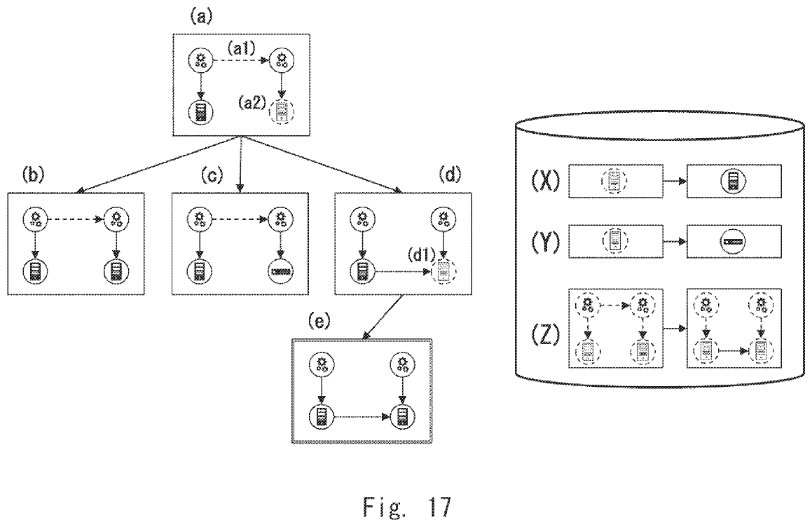

FIG. 17 shows an example of processing for designing a system configuration performed by the learning-type system automatic design apparatus 310.

As shown in FIG. 17, a system requirement (a) includes two abstract elements (a1) and (a2). Concretization rules (X) and (Y) can be applied to (a1), and a concretization rule (Z) can be applied to (a2). Therefore, the learning-type system automatic design apparatus 310 generates three system configuration plans (b), (c), and (d) by applying these concretization rules to (a1) and (a2). Then the learning-type system automatic design apparatus 310 evaluates each generated system configuration plan by GNN, and selects (d) having the highest evaluation value as the next target to be concretized. The only abstract element included in the system configuration plan (d) is (d1), and the concretization rules (X) and (Y) can be applied to (d1). Therefore, first, the learning-type system automatic design apparatus 310 applies the concretization rule (X) to (d1), and as a result, a concrete system configuration plan (e) that does not include an abstract elements is obtained. Therefore, the learning-type system automatic design apparatus 310 completes the design, and adds (e) as a system configuration to the system configuration group 400.

### <Operation in Third Example Embodiment>

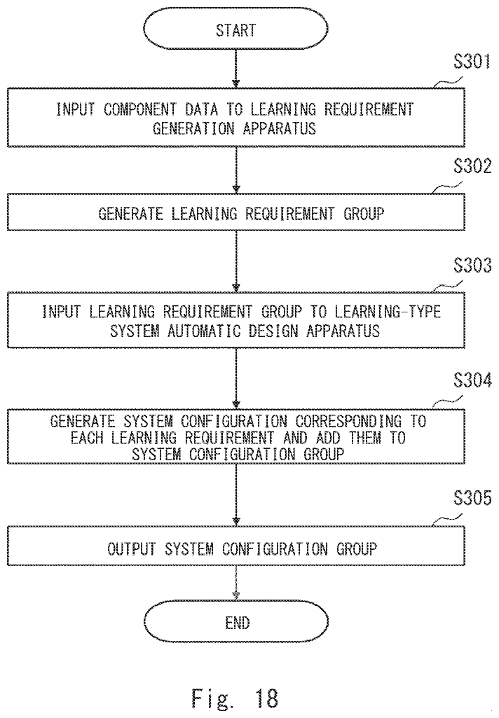

Next, an example of a flow of an overall operation performed by the automatic design system according to the third example embodiment will be described with reference to a flowchart of FIG. 18.

As shown in FIG. 18, first, the learning requirement generation apparatus 100 inputs the component data 200 (Step S301). Next, the learning requirement generation apparatus 100 generates the learning requirement group 300 (Step S302).

Next, the learning-type system automatic design apparatus 310 inputs the learning requirement group 300 generated in Step S302 (Step S303). Next, for the respective learning requirements that compose the input learning requirement group 300, the learning-type system automatic design apparatus 310 recursively executes the application of the concretization rule to the abstract element of the learning requirement and the evaluation of the system configuration plan to which the concretization rule has been applied. By doing the above, the learning-type system automatic design apparatus 310 generates a concrete system configuration corresponding to the learning requirement, and adds it to the system configuration group 400 (Step S304).

After that, the learning-type system automatic design apparatus 310 outputs the system configuration group 400, and ends the process (Step S305).

### <Effect of Third Example Embodiment>

As described above, in the automatic design system according to the third example embodiment, the learning-type system automatic design apparatus 310 generates a concrete system configuration corresponding to each learning requirement generated by the learning requirement generation apparatus 100. Therefore, it is possible to automatically generate a concrete system configuration corresponding to each learning requirement.

The effects of the third example embodiment other than the above ones are similar to those of the above-described first example embodiment.

Note that the automatic design system according to the third example embodiment may include the learning requirement generation apparatus 100A according to the above-described second example embodiment instead of the learning requirement generation apparatus 100 according to the above-described first example embodiment.

### Fourth Example Embodiment

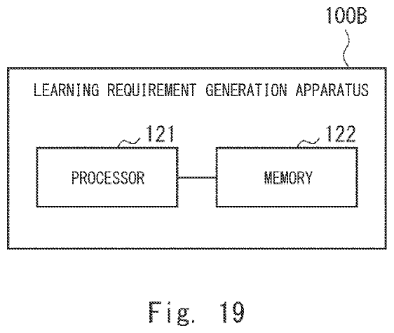

FIG. 19 shows a configuration example of a learning requirement generation apparatus 100B according to a fourth example embodiment. As shown in FIG. 19, the learning requirement generation apparatus 100B includes a processor 121 and a memory 122.

The processor 121 may be, for example, a microprocessor, a Micro Processing Unit (MPU), or a Central Processing Unit (CPU). The processor 121 may include a plurality of processors.

The memory 122 is composed of a combination of a volatile memory and a non-volatile memory. The memory 122 may include a storage located separately from the processor 121. In this case, the processor 121 may access the memory 122 via an Input/Output (I/O) interface (not shown).

Each of the learning requirement generation apparatuses 100 and 100A according to the above-described first and second example embodiments can have the hardware configuration shown in FIG. 19. A program is stored in the memory 122. This program includes instructions (or software codes) that, when loaded into a computer, cause the computer to perform one or more of the functions described in the above-described example embodiments. The requirement acquisition units 102 and 111, the learning requirement generation units 103 and 114, the extension requirement generation unit 112, and the similarity requirement acquisition unit 113 included in the above-described learning requirement generation apparatuses 100 and 100A may be implemented by the processor 121 loading and executing the program stored in the memory 122. Further, the storage unit 101 included in the above-described learning requirement generation apparatuses 100 and 100A may be implemented by the memory 122.

Further, the above-described program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The industrial applicability of the present disclosure is obvious from the above description, and the present disclosure can be applied to applications such as the design and construction of an ICT system and a communication network.

Although the present disclosure has been described above with reference to example embodiments, the present disclosure is not limited to the above-described example embodiments. Various changes that may be understood by those skilled in the art may be made to the configurations and details of the present disclosure within the scope of the disclosure.

The first to fourth example embodiments can be combined as desirable by one of ordinary skill in the art.

What is claimed is:

1. A learning requirement generation apparatus comprising:
a storage unit configured to store a system requirement group;
a requirement acquisition unit configured to acquire the system requirement group from the storage unit and add the acquired system requirement group to an acquisition requirement group; and
a learning requirement generation unit configured to generate a learning requirement by adding or replacing of a component on each of acquisition requirements that compose the acquisition requirement group.

2. The learning requirement generation apparatus according to claim 1, wherein
the learning requirement generation unit inputs component data representing an input component,
for each of the acquisition requirements that compose the acquisition requirement group, when the input component is included in the acquisition requirement and the input component can be connected to a new component, the learning requirement generation unit is configured to generate the learning requirement by adding a new component to the acquisition requirement and by connecting the added new component to the input component, and
for each of the acquisition requirements that compose the acquisition requirement group, when the input component is not included in the acquisition requirement and a component that can be replaced with the input component is included in the acquisition requirement, the learning requirement generation unit is configured to generate the learning requirement by replacing the component included in the acquisition requirement with the input component.

3. The learning requirement generation apparatus according to claim 2, wherein
the learning requirement generation unit stores the generated learning requirement in the storage unit and adds the generated learning requirement to a learning requirement group, and
the learning requirement generation unit outputs the learning requirement group.

4. The learning requirement generation apparatus according to claim 1, wherein
the requirement acquisition unit inputs component data representing an input component,
the requirement acquisition unit acquires the system requirement group including the input component from the storage unit and adds the acquired system requirement group to the acquisition requirement group,
the learning requirement generation apparatus further comprises:
an extension requirement generation unit configured to, for each of the acquisition requirements that compose the acquisition requirement group, when the input component is included in the acquisition requirement and the input component can be connected to a new component, generate an extension requirement by adding a new component to the acquisition requirement and by connecting the added new component to the input component, and then add the generated extension requirement to an extension requirement group; and
a similarity requirement acquisition unit configured to, for each of extension requirements that compose the extension requirement group, acquire a system requirement from the storage unit, the system requirement being similar to the extension requirement and not including the input component, and add the acquired system requirement to a similarity requirement group, and
for each of the similarity requirements that compose the similarity requirement group, when a component that can be replaced with the input component is included in the similarity requirement, the learning requirement generation unit is configured to generate the learning requirement by replacing the component included in the similarity requirement with the input component.

5. The learning requirement generation apparatus according to claim 4, wherein
the extension requirement generation unit stores the generated extension requirement in the storage unit,
the learning requirement generation unit stores the generated learning requirement in the storage unit and adds the generated learning requirement to the learning requirement group, and
the learning requirement generation unit outputs the learning requirement group.

6. The learning requirement generation apparatus according to claim 4, wherein
the similarity requirement acquisition unit determines, by using a Dice coefficient, a similarity between each of the system requirements that do not include the input components and each of the corresponding extension requirements, the system requirements and the extension requirements having been stored in the storage unit, and
the similarity requirement acquisition unit acquires the system requirement having a highest similarity to one of the extension requirements from the storage unit, and adds the acquired system requirement to the similarity requirement group.

7. A learning requirement generation method performed by a learning requirement generation apparatus, the learning requirement generation method comprising:
storing a system requirement group in a storage unit;
acquiring the system requirement group from the storage unit and adding the acquired system requirement group to an acquisition requirement group; and
generating a learning requirement by adding or replacing of a component on each of acquisition requirements that compose the acquisition requirement group.

8. A non-transitory computer readable medium storing a program for causing a computer to execute:
a procedure of storing a system requirement group in a storage unit;
a procedure of acquiring the system requirement group from the storage unit and adding the acquired system requirement group to an acquisition requirement group; and
a procedure of generating a learning requirement by adding or replacing of a component on each of acquisition requirements that compose the acquisition requirement group.
